(19) United States
(12) Patent Application Publication
(10) Pub. No.: US 2026/0124778 A1
(43) Pub. Date: May 7, 2026

(54) DEVICE AND METHOD FOR CUTTING A STRIP MADE OF A DEFORMABLE MATERIAL

(71) Applicant: KRAUSSMAFFEI EXTRUSION GMBH, Laatzen (DE)

(72) Inventors: Martin SEIFFERT, Elze (DE); Uwe KRÖGER, Laatzen (DE)

(21) Appl. No.: 19/118,192

(22) PCT Filed: Oct. 30, 2023
(86) PCT No.: PCT/EP2023/080251

§ 371 Date: Apr. 3, 2025

(30) Foreign Application Priority Data
Nov. 16, 2022 (DE) 10 2022 130 333.0

(51) Int. Cl. B26D 7/08; B26D 1/08; B26D 3/00; B26D 7/32; B29C 48/00; B29C 48/07; B29C 48/28; B29C 48/355; B29L 30/00

(52) U.S. Cl. CPC B26D 7/08; B26D 1/085; B26D 3/003; B26D 7/32; B29C 48/0022; B29C 48/022; B29C 48/07; B29C 48/28; B29C 48/355; B26D 2007/082; B29C 2793/0027; B29C 2793/009; B29L 2030/00

(57) ABSTRACT

The application relates to a separate device for cutting a strip made of a deformable material, having a transport device, through the separating device along a transport direction and a cutting device for cutting the strip along a cutting surface using a cutting blade, which runs downwards from above diagonally in the transport direction through the strip lying on the transport device. The transport has a depression in the region of the cutting device in order to receive the cutting blade when cutting the strip, wherein the beginning of the depression defines a first edge when viewed in the transport direction, and the end of the depression defines a second edge when viewed in the transport direction. The transport device is suitable for raising the first edge relation to the second edge after cutting the strip until the tip of the strip part which is not cut off has been transported over the second edge by the transport device.

The present invention relates to a device and a method for cutting a strip made of a deformable material, in particular a tyre semi-finished product.

In present-day production, it is known to produce a variety of deformable materials in strip form, e.g. by pressing, extruding or suchlike. The production takes place here frequently in the form of endless strips, i.e. the strip is initially produced without interruption. An example of such a production is the production of tyre semi-finished products, for instance of treads or side strips of tyres, in particular of motor vehicle tyres, by means of an extruder.

For the portioning and further processing, such a strip must be cut from deformable material. Often, it is technically necessary that the cut runs diagonally through the material, in particular when the cutting surface is to serve as a joining location for connections of the strip which has been cut off, as then the connection area is enlarged. In particular in tyre production, the cut tyre semi-finished product is shaped into cylinders by the two cutting surfaces of the semi-finished product being stuck together. The diagonal cutting surface provides a better adhesion of the cutting surfaces owing to their enlarged area compared to a perpendicular cut.

The material strips are often structured differently on their two sides. For example, a tread semi-finished product of a motor vehicle tyre has a profile surface on one side, on which the tyre pattern is formed, whereas the other side is formed for the connection with the interior layers of the tyre.

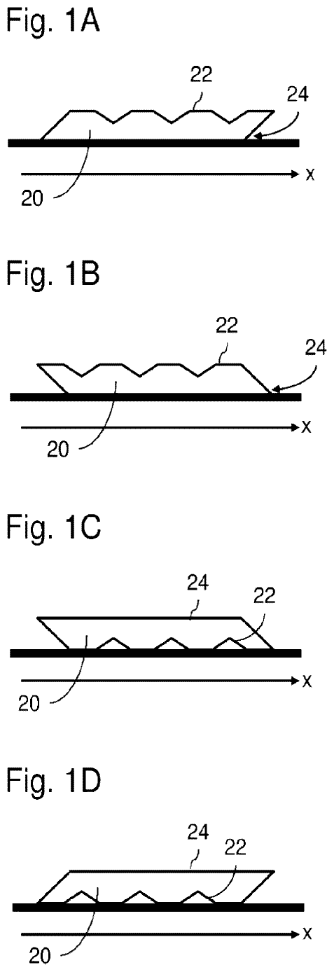

As two possibilities exist for the course of the cutting surface, namely a cut against or with the transport direction, and as owing to the different surfaces of the strip a difference exists between the two location positions of the strip, basically four possibilities exist for the case described above for depositing finished cut material strips. These are shown in FIG. 1A to 1D.

FIG. 1A shows the case where a strip 20 was cut diagonally against the transport direction x. An upper side 22 (e.g. a profile side) points upwards. The strip lies on its underside 24. Viewed in the transport direction x, the upper side 22 therefore extends further forward than the underside 24.

FIG. 1B shows the case where the strip 20 was cut diagonally with the transport direction x. The upper side 22 again points upwards and the strip 20 lies on its underside 24. Viewed in transport direction x, the underside 24 now extends, however, further forward than the upper side 22.

In FIGS. 1C and 1D the strip 20 is cut as in FIGS. 1A and 1B, but is then turned before depositing along its longitudinal axis, i.e. the underside 24 points upwards and the upper side 22 points downwards.

A simple technical realization of these four possibilities of deposition currently exists only for the cases shown in FIGS. 1A and 1C, i.e. for a cut diagonally against the transport direction. The reason for this is that in the case of a cut with the transport direction a tip occurs at the front on the underside of the material strip. This can be deformed in particular shortly after the cut by abutting against the conveying mechanism in the cutting apparatus, whereby the material strip can become unusable or respectively the material waste can be increased.

On the other hand, it can be advantageous for the optimization of the further processing of the cut strips if these are deposited as shown in FIGS. 1B and 1D. Currently, however, this is only possible with great effort. It is indeed possible to turn the cut material strips around through 180° before depositing. However, this is technically relatively laborious and cost-intensive. In addition, the space requirement of the system is increased. Alternatively, it is also possible to turn the deposition station, for instance a leaf truck in the production of tyre semi-finished products, through 180°. Hereby, however, also the complexity, the costs and often also the space requirement of the system are increased.

The object of the present invention is therefore to indicate a device and a method for cutting a strip made of deformable material, by which the above-mentioned problems can be solved. In particular also the deposition positions shown in FIGS. 1B and 1D are to be made possible by the strip being cut in transport direction without deforming it.

This problem is solved by the subject of the independent claims.

A separating device for cutting a strip made of a deformable material has a transport device for transporting the strip, which lies on the transport device, through the separating device along a transport direction and a cutting device for cutting the strip along a cutting surface using a cutting blade, which runs downwards from above diagonally in the transport direction through the strip lying on the transport device. The transport device has here a depression in the region of the cutting device in order to receive the cutting blade when cutting the strip, wherein a beginning of the depression defines a first edge when viewed in the transport direction, and an end of the depression defines a second edge when viewed in the transport direction. The transport device is suitable for raising the first edge relative to the second edge after cutting the strip until a tip of the strip part which is not cut off has been transported over the second edge by the transport device.

The separating device is therefore basically constructed in a known manner. A transport device, e.g. a conveyor belt or a roller belt transports an in particular endless material strip to a cutting device, in which a cutting blade, e.g. a rotating cutter, a laser—or an ultrasound blade, successively separates the respectively front part of the material strip. The cutting blade dips here during the cutting process into a depression in the transport device, which can be formed as a groove or a channel running transversely to the transport direction. The depression forms here at its beginning a first edge, and at its end a second edge in the surface of the transport device. In order to bring the part of the strip which has not been separated in position for a further positioning, it must be displaced over the depression.

In contrast to the systems known per se, the cutting blade of the cutting device is, however, arranged such that it produces a cutting surface which runs downwards from above diagonally in transport direction. The side of the part of the strip which has not been separated, lying on transport device lies further forward, viewed in transport direction, than the upper side of the strip.

If this part which has not been separated is displaced over the depression of the cutting device, the risk exists that it abuts against the second edge of the depression, as the deformable material of the strip can sink into the depression and can hence lie lower than the surface of the transport device adjoining the depression in transport direction. In order to solve this problem, the first edge can be raised relative to the second edge, or respectively the second edge can be lowered relative to the first edge. Thereby, it is ensured that the shifted tip of the strip does not abut against the walls of the depression, but rather arrives without deformation onto the upper side of the transport device adjoining the depression. If the tip is brought over the second edge, the relative position of the first and of the second edge can be equalized again, in order to create identical starting conditions for the next cut.

The transport device can be suitable here for raising a first supporting surface of the strip in the region before the first edge, and/or for lowering a second supporting surface of the strip in the region after the second edge. The change to the relative position therefore takes place through a change to the height position of the supporting surfaces in front and/or behind the depression. For example, the transport device can be divided in two in the region of the cutting device by the depression, so that the height of the transport device in front and behind the depression can be changed independently of one another. The height change can be brought about here e. g. by hydraulic actuators or electric motors.

The transport device can be suitable here for realizing the raising of the first supporting surface or respectively the lowering of the second supporting surface by linear, vertical movements of the supporting surfaces. For example, hydraulic actuators can move the first supporting surface upwards or respectively the second supporting surface downwards (or both).

The transport device can, however, also have an axis running horizontally and perpendicularly to the transport direction and can be suitable for rotating the supporting surface of the strip in the region of the depression in transport direction about the axis in such a way that the first edge is raised relative to the second edge. The transport device therefore then has in the region of the cutting device e.g. a block which is mounted rotatably on the axis, on the upper side of which the supporting surfaces and the depression are formed. When this block is rotated in transport direction out from a position in which the supporting surfaces lie at equal height, the second edge lowers more than the first edge. Hereby, an abutting of the shifted strip against the walls of the depression is prevented in a simple manner. In addition, the rotational movement in transport direction assists the further transport of the part of the strip which is not cut off.

The strip made of deformable material can be, in particular, a tyre semi-finished product, e. g. a tread or a side strip. The above-mentioned advantages can thus be used for the tyre production.

An extrusion device for producing a strip-shaped caoutchouc extrudate, in particular of tyre semi-finished products, has at least one extruder for producing the strip-shaped caoutchouc extrudate, a separating device for cutting the strip-shaped caoutchouc extrudate, as was described above, a material feed for the feeding of starting materials for the production of the caoutchouc extrudate to the extruder, and a storage place for the depositing of parts of the strip-shaped caoutchouc extrudate which are cut off in the separating device. The extruder, the separating device and the storage place are connected here by a conveying section, and the material feed and the storage space are arranged on the same side of the conveying section.

The extrusion device therefore has a structure which is typical per se. Here, however, the use of the separating device described above makes it possible that the extrudates can be deposited in the storage place, for instance a leaf truck, with an alignment as shown in FIG. 1B, while the relatively compact structure of the extrusion device, known per se, can be retained without having to add further system components.

The extrusion device can have, furthermore, a turning device which is suitable for turning about their longitudinal axis the parts which have been cut off in the separating device, before they are deposited in the storage place. Therefore, extrudates can also be deposited with the alignment shown in FIG. 1D with the extrusion device through use of the turning device, known per se, and the separating device according to the invention.

A method for cutting a strip made of a deformable material by means of a separating device as has been described above comprises: transporting the strip, lying on the transport device, through the separating device along a transport direction; cutting the strip by means of the cutting blade along a cutting surface, which runs downwards from above diagonally in the transport direction through the strip lying on the transport device; and raising the first edge relative to the second edge after cutting the strip until a tip of the part of the strip which is not cut off has been transported over the second edge by the transport device.

This method permits material strips to be produced having cutting edges which permit a simple deposition of the material strips in orientations which were previously only able to be achieved with a comparatively great effort in terms of apparatus.

The present invention is explained further in the following with reference to the figures. This description is to be understood as being solely by way of example and is not meant to limit the claimed subject. The invention is defined solely through the subject of the independent claims. There are shown:

FIG. 1A to 1D schematic illustrations of various deposition possibilities of diagonally cut material strips;

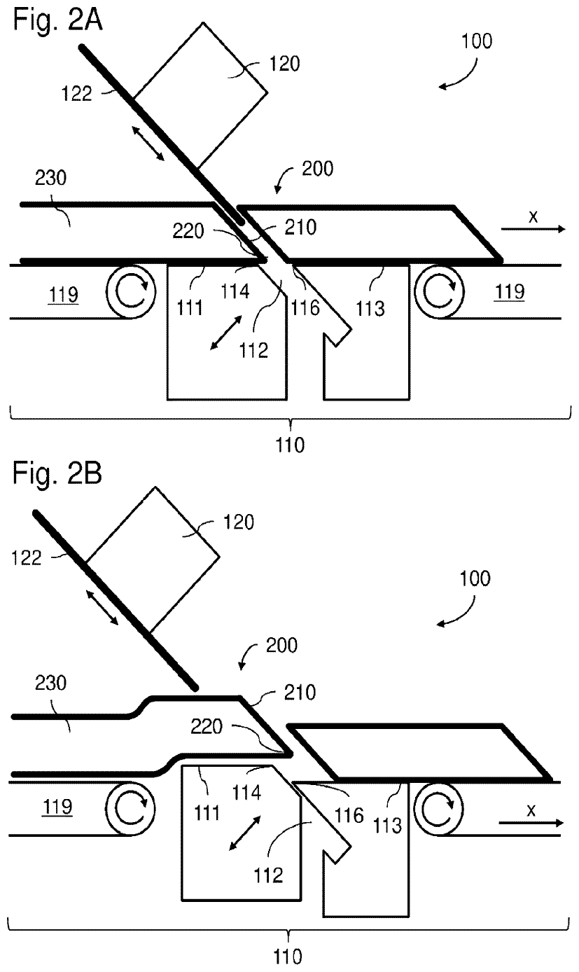

FIG. 2A and 2B Schematic Illustrations of a Separating device;

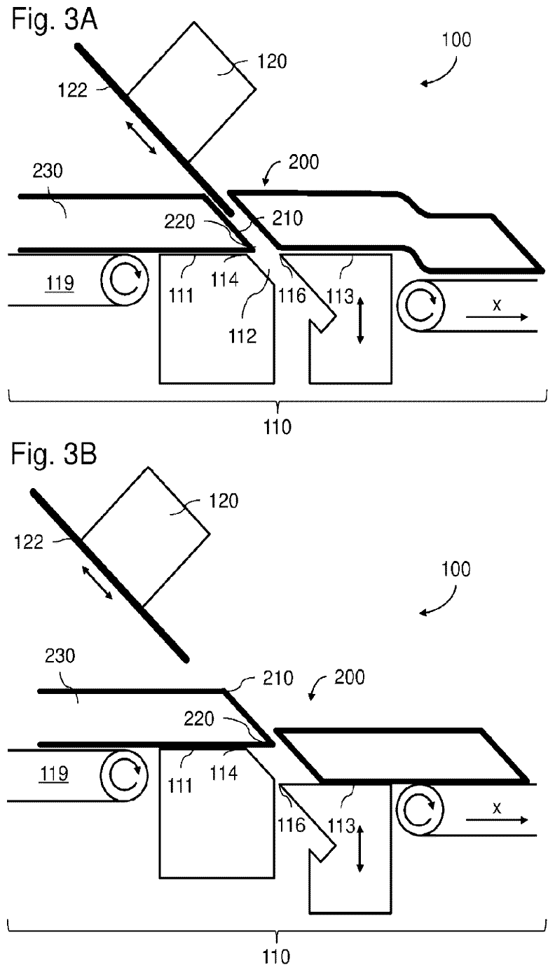

FIGS. 3A and 3B schematic illustrations of a further separating device;

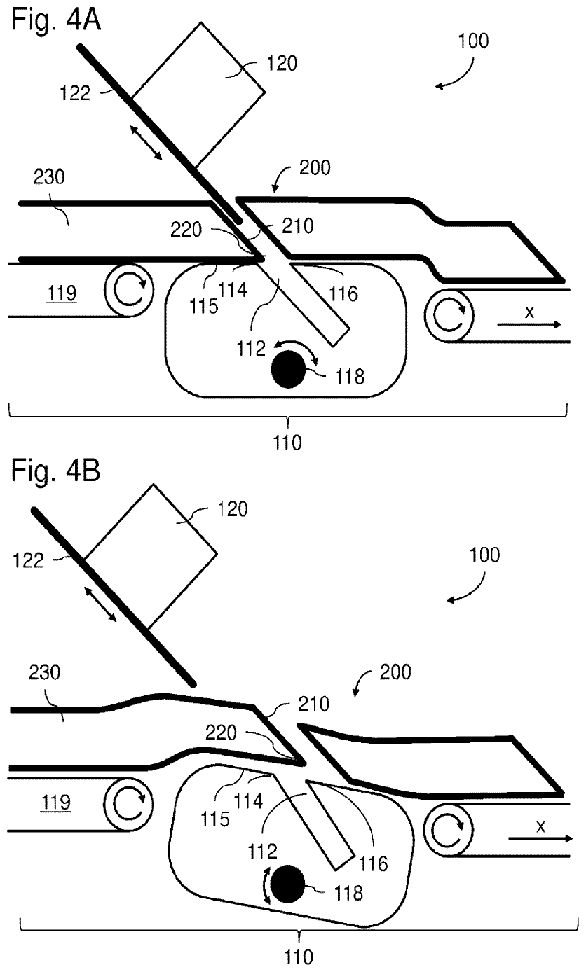

FIGS. 4A and 4B schematic illustrations of a further separating device;

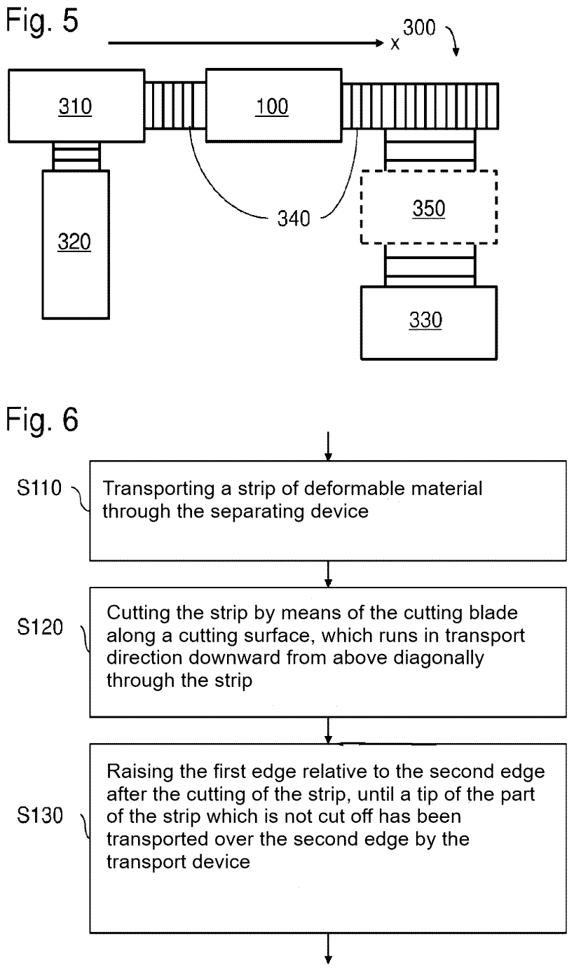

FIG. 5 a schematic illustration of an extrusion device; and

FIG. 6 a flowchart of a method for cutting deformable material.

FIGS. 2A and 2B show in a schematic manner a separating device 100 for cutting a strip 200 made of a deformable material. The strip 200 can originate here from any source and can consist of any deformable material. Preferably, however, it concerns an extrudate made of rubber or caoutchouc, further preferably a tyre semi-finished product, for instance a tread or a side strip. Furthermore, the strip 200 preferably concerns an endless product which is cut in the separating device 100 into parts of a desired length. The separating device 100 can, however, also be used for cutting material strips having a finite length.

The separating device 100 has a transport device 110 and a cutting device 120.

The transport device 110 serves for the transporting of the strip, lying on the transport device 110, through the separating device 100 along a transport direction x. For this, the transport device 100 has any transport mechanisms known per se, such as e.g. conveyor belts, roller belts and suchlike. In FIGS. 2A and 2B, conveyor belts 119 are shown purely by way of example, which convey the material strip 200 up to the cutting device 120 and away from the latter.

The cutting device 120 has a cutting blade 122 by which the front part of the material strip 200 can be separated. For this, the cutting blade 122 can be guided in the plane of its cutter from above through the strip 200. The cutting blade 122 can be provided e.g. with an electrically operated rotating cutter. In principle, however, other embodiments, known per se, are also possible.

The term “cutting blade” is meant here to comprise not only embodiments in which the material strip 200 is separated mechanically. In this sense, a cutting blade can also be formed by a device for cutting by means of laser or ultrasound. The decisive factor here is that through the cut a surface is produced which permits a subsequent joining process, e.g. by rolling of the cut-off strips and bonding of the front and rear cutting surface during the tyre production.

As shown in FIG. 2A, the cutting blade 122 dips into the strip 200 from the rear, viewed in transport direction x, and cuts through it diagonally toward the front. Hereby, a cutting surface 210 is produced, which runs in transport direction x downwards from above diagonally through the strip 200 lying on the transport device 110. The part 230 of the strip 200 which is not separated off therefore has a tip 220 on its underside, i.e. on the side lying on the transport device 110.

In order to achieve a complete separation through of the strip 200 without damage to the transport device 110, this has a depression 112 in the region of the cutting device 120, which can receive the cutting blade 122 during cutting of the strip 200. The depression 112 runs here transversely to the transport direction x through the transport device 110, in order to enable a separating through of the strip 200 in its entire width. As shown in FIG. 2A, the depression 112 can have a contour which is adapted to the inclination of the cutting blade 122. In principle, however, the depression 112 can have any shape as long as it is ensured that the cutting of the strip 200 can take place without damage to the transport device 110.

Furthermore, the cutting blade 122 can also cut through the strip 200 from below out of the depression 112. The cutting blade can then withdraw into the depression 112 again after the cut. In the case of a non-mechanical cut, e.g. by means of laser or ultrasound the cut can begin from below or above, wherein the energy source generating the laser or ultrasound is switched off after the cut.

As shown in FIGS. 2A and 2B, the transport device 110 can have a region lying between active conveying elements, in which the depression 112 is formed. In the example of FIGS. 2A and 2B, this region lies between two conveyor belts 119 which generate the propulsion of the material strip 200, whereas no propulsion is generated in the intermediate region itself. The transport device 110 can thus have a region manufactured substantially from metal, such as for instance a metal block, in which the depression 112 is formed e.g. by a machining process. The depression 112 can, however, also be formed by a gap between two conveying mechanisms lying adjacent to one another, e.g. as a gap between two conveyor belts 119.

The depression 112 defines edges 114, 116 in the surface of the transport device, lying along the transport path of the strip. Viewed in transport direction x, a beginning of the depression 112 defines a first edge 114, and an end of the depression 112 defines a second edge 116. The term “edge” is intended to include here not only transitions at which two surfaces abut one another at a particular angle, such as arise e.g. in the case of a depression 112 milled into a metal block, but also curves by which the depression 112 begins and ends. For example the ends of conveyor belts 119 are thus also to be understood as edges when the depression 112 is formed by a gap between conveyor belts 119. An edge is therefore in particular the transition of the upper or respectively conveying surface of the transport device 110 to the free space created by the depression 112.

If the material strip 200 as described above is cut in such a way that the remaining part 230 of the strip 200 has a tip 220 lying on the upper side of the transport device 110, the risk exists that this tip lowers into the free space created by the depression 112 in the course of the propulsion of the remaining part 230, and is pushed against the second edge 116 or respectively the part of the transport device 110 lying beneath the second edge 116. This results, on the one hand, in a deformation of the strip 200. On the other hand, the strip 200 is conveyed further into the depression in this way, without manual correction, which can lead to a damage to the transport device 110 and to a great loss of material.

In order to circumvent this problem, the transport device 110 is suitable for raising the first edge 114 relative to the second edge 116 after the cutting of the strip 200 until the tip 220 of the part 230 of the strip 200 which has not been cut off has been transported over the second edge 116 by the transport device 110.

By changing the height level of the first edge 114 over the level of the second edge 116, the section is increased by which the strip 220 can lower after it has lost contact with the first edge 114. Hereby, sufficient time is gained to move the part 230 of the strip 200, which is not cut off, beyond the second edge 116, so that the tip 220 also in the case of a lowering on the second edge 116 or further in transport direction x comes to lie on the transport device 110.

As the lowering of the tip 220 typically takes place at a speed which is less than or equal to the conveying speed through the separating device 100, it is sufficient to raise the first edge 114 relative to the level of the second edge 116 by a section which corresponds approximately to the width of the depression 112 in transport direction x. If the transport speed is higher than the lowering speed, an offset by a smaller amount may also be sufficient.

The manner as to how the relative offset between the first edge 114 and the second edge 116 is achieved in the transport device 110 is arbitrary here, as long as it is guaranteed hereby that the part 230 of the strip 200 which is not cut off is not deformed at or in the depression 112 or remains stuck.

The manner as to how the producing of the relative offset is triggered is also arbitrary, as long as the above-mentioned result is achieved. It is thus conceivable e.g. to use a control device, such as a computer, a processor, a program or suchlike which, based on sensor data, such as for instance camera data, motion data of the transport device 110 and of the cutting device 120 and suchlike triggers the generating of the relative offset. However, it is also possible to trigger the offset purely mechanically, e.g. by the movement of the transport device 110, of the material strip 200 or of the cutting device 120 actuating a lever, a rocker or a switch which then in turn triggers the generating of the offset. In addition, for constructive reasons the offset can always be produced automatically after the cutting process has been completed.

After the tip 220 has passed the second edge 116, the transport device is brought again into its starting position. This prevents an excess deformation of the material strip 200 owing to the height offset in the conveying section and facilitates the conveying. In addition, through the returning into the starting position, a problem-free transferring of the material strip 200 over the depression 112 is also enabled at the next cutting process.

FIGS. 2A and 2B show by way of example a possibility to produce the offset, discussed above, between first edge 114 and second edge 116. As shown in FIGS. 2A and 2B, the transport device 110 is configured as a two-part block in the region of the cutting device 120, wherein both parts of the block define the depression 112. The first edge 114 is thus formed on the part lying upstream in transport direction x, and the second edge 116 is formed on the part lying downstream. The part lying upstream can be moved upwards, e.g. hydraulically or electrically, and thereby brings the first edge 114 to a height level above the second edge 116.

In the example of FIGS. 2A and 2B, the movement in transport direction runs diagonally upwards. This has the advantage that the depression 112 not only has to be bridged through the propulsion of the part 230 of the strip 200 which is not cut off, but also is partially closed by the movement of the first edge 114. In this way, it is possible to reliably bring the tip 220 of the part 230, which has not been cut off, over the second edge 116 without deformation. After this has taken place, the two-part block is brought into its starting position again for a further cutting process.

It is self-evident that FIGS. 2A and 2B are purely by way of example here and are not true to scale. Thus, e.g. the horizontal extent of the block arranged in the region of the cutting device 120 is illustrated in an exaggerated manner for reasons of clarity. In addition, the two parts of the block can also be connected to one another in a movable manner. Also, the parts of the block do not have to be solid in configuration. Rather, they can also be formed as a comparatively thin first supporting surface 111 and second supporting surface 113, which are held in a movable manner by a support structure. The supporting surfaces 111, 113 can also have movable elements here such as rollers or conveyor belts, which facilitate the propulsion of the strip 200 over the supporting surfaces 111, 113. Furthermore, additionally or alternatively to the raising of the first edge 114, the second edge 116 can also be lowered.

For the example of FIGS. 1A and 2B it is crucial that the transport device 110 is suitable for raising the first supporting surface 111 in the region before first edge 114 and/or for lowering the second supporting surface 113 in the region after the second edge 116. Thereby, a secure transition is achieved over the depression 112, although a tip 220 lying below was produced by the cut.

In the example of FIGS. 2A and 2B the first supporting surface was moved diagonally upwards in order to bridge the depression. However, it can also be sufficient to realize the raising the first supporting surface 111 or respectively the lowering of the second supporting surface 113 through linear, vertical movements of the supporting surfaces 111, 113.

This is shown schematically and purely by way of example in FIGS. 3A and 3B. The structure of FIG. 3A corresponds here to the structure of FIG. 2A. Instead of moving the front part of the block with the first supporting surface 111, the part of the block lying downstream with the second supporting surface 113 is moved linearly downwards. Hereby also the transition created by the depression 112 can be closed and the part 230 of the strip 200 which is not cut off can be brought securely without deformation over the second edge 116. A purely linear, vertical movement can, in addition, simplify the structure of the system.

As shown in FIGS. 3A and 3B, it can be advantageous here if the part of the transport device 110 lying downstream is arranged at a height level which corresponds to the level of the lowered second edge 116, as in this case the cut-off part of the strip 200 can be transported away without further deformation.

In the above-mentioned examples, the offset between first edge 114 and second edge 116 was produced through linear movements of two separate supporting surfaces 111, 113. Alternatively or additionally, the offset can for example also be achieved by a rotation of the component of the transport device 110 containing the depression 112.

For this, the transport device 110 can have an axis 118 running horizontally and perpendicularly to the transport direction x and can be suitable for rotating a supporting surface 115 of the strip 200 in the region of the depression 112 about the axis 118 in transport direction x in such a way that the first edge 114 is raised relative to the second edge 116.

A schematic exemplary structure of such an arrangement is shown in FIGS. 4A and 4B. The structure corresponds substantially to the structure of FIG. 2A to 3B wherein, however, the two-part block was replaced by an element rotatable about the axis 118. The rotatable element has the depression 112 lying in the supporting surface 115. After the cutting through of the material strip 200, the rotatable element is rotated in transport direction x. Hereby the first edge 114 is raised relative to the second edge 116. At the same time, the part 230 of the strip 200 which is not cut off is drawn in transport direction x. The rotation about the axis 118 thereby assists the propulsion of the part 230 which is not cut off. Thereby, its tip 220 can arrive over the second edge 116 without deformation, and the strip 200 can subsequently be positioned for the next cut. For this, the rotatable element is rotated again into its starting position.

Although in FIGS. 4A and 4B the rotatable element was illustrated with a planar supporting surface 115 for the sake of simplicity, the supporting surface can also be curved. For example, the rotatable element can be configured as a roller with a slit forming the depression 112. The first edge 114 therefore does not necessarily have to be arranged at the height level of the second edge 116 during the cutting process. It can also lie below or over this level. This also applies in principle to the variants shown in FIG. 2A to 3B.

It is self-evident that in addition to the embodiments described above, a wide range of variants exists for the increasing of a distance between the first edge 114 and the second edge 116. The embodiments described above are therefore not to be understood as restrictive. It is crucial that after the cut through the strip 200, the part 230 of the strip 200 which is not cut off, lying upstream, is raised relative to the cut off part. This prevents the tip 220, formed below on the part 230 lying upstream, from becoming caught in the depression 112 for the cutting blade 122.

The separating device 100 described above can be advantageously used in an extrusion device 300, as is illustrated schematically in FIG. 5.

The extrusion device 300 serves for the production of strip-shaped caoutchouc extrudates, in particular of tyre semi-finished products and has at least one extruder 310 for producing the strip-shaped caoutchouc extrudates, a separating device 100 as was described above for cutting the strip-shaped caoutchouc extrudates, a material feed 320 for the feeding of starting materials for the production of the caoutchouc extrudates to the extruder 310, and a storage place 330 for the depositing of parts of strip-shaped caoutchouc extrudates which are cut off in the separating device 100. The extruder 310, the separating device 100 and the storage place 330 are connected by a conveying section 340, and the material feed 320 and the storage place 330 are arranged on the same side of the conveying section 340.

The extrusion device 300 shown in FIG. 5 therefore corresponds in its structure to a structure known per se, in which for reasons of logistics and space the delivery of the starting materials for the extrudate and the removal of the finished cut strips are to take place on the same side of the system.

However, through the separating device 100 described above, it is possible to lay into the storage place the cut material strips with a tip lying in transport direction x and on the underside of the strips, without having to laboriously adapt the structure of the extrusion device 300 which is known per se. Thereby further processing steps which require such a storage space for an optimized processing can be realized without additional effort.

Optionally, the extrusion device 300 can also have a turning device 350, known per se, which is suitable for turning about their longitudinal axis the parts which are cut off in the separating device 100 before they are deposited in the storage space 340. Thereby, a further orientation of the cut strips can be made available within the already known process work. This can also serve to optimize further processing steps.

FIG. 6 shows a schematic flowchart of a method for the cutting of strips made of a deformable material using a separating device 100 as was described above.

At S 110 the strip 200, lying on the transport device 110, is transported through the separating device 100 along a transport direction x.

At S 120 the strip 200 is cut by means of the cutting blade 122 along a cutting surface 210, which runs in transport direction x downwards from above diagonally through the strip 200 lying on the transport device 110.

At S 130 the first edge 114 is raised relative to the second edge 116 after the cutting of the strip 200, until a tip 220 of the part 230 of the strip 200 which is not cut off has been transported over the second edge 116 by the transport device 110.

Hereby, the above-mentioned advantages can be achieved or respectively the problems named in the introduction can be solved.

### List of Reference Numbers

100 separating device
110 transport device
111 first supporting surface
112 depression
113 second supporting surface
114 first edge
115 supporting surface
116 second edge
118 axis
119 conveyor belts
120 cutting device
122 cutting blade
200 strip of deformable material
210 cutting surface
220 tip
230 part of the strip which is not cut off
300 extrusion device
310 extruder
320 material feed
330 storage place
340 conveying section
350 turning device

1. A separating device for cutting a strip made of a deformable material, having:
a transport device for transporting the strip, which lies on the transport device, through the separating device along a transport direction; and
a cutting device for cutting the strip along a cutting surface using a cutting blade, which runs downwards from above diagonally in the transport direction through the strip lying on the transport device, wherein
the transport device has a depression in the region of the cutting device in order to receive the cutting blade when cutting the strip;
a beginning of the depression defines a first edge when viewed in the transport direction, and an end of the depression defines a second edge when viewed in the transport direction; and
the transport device is suitable for raising the first edge relative to the second edge after the cutting of the strip until a tip of the part of the strip which is not cut off has been transported over the second edge by the transport device.

2. The separating device according to claim 1, wherein
the transport device is suitable for raising a first supporting surface of the strip in the region before the first edge and/or for lowering a second supporting surface of the strip in the region after the second edge.

3. The separating device according to claim 2, wherein
the transport device is suitable for realizing the raising of the first supporting surface or respectively the lowering of the second supporting surface by linear, vertical movements of the supporting surfaces.

4. The separating device according to claim 1, wherein
the transport device has an axis running horizontally and perpendicularly to the transport direction and is suitable for rotating the supporting surface of the strip in the region of the depression in transport direction about the axis in such a way that the first edge is raised relative to the second edge.

5. The separating device according to claim 1, wherein the strip of deformable material is a tyre semi-finished product.

6. An extrusion device for producing a strip-shaped caoutchouc extrudate, having:
at least one extruder for producing the strip-shaped caoutchouc extrudate;
a separating device according to claim 1 for cutting the strip-shaped caoutchouc extrudate;
a material feed for the feeding of starting materials for the production of the caoutchouc extrudate to the extruder; and
a storage place for the depositing of parts of the strip-shaped caotchouc extrudate which are cut off in the separating device; wherein
the extruder, the separating device and the storage place are connected by a conveying section, and the material feed and the storage place are arranged on the same side of the conveying section.

7. The extrusion device according to claim 6, furthermore with a turning device, which is suitable for turning about their longitudinal axis the parts cut off in the separating device before they are deposited in the storage place.

8. A method for cutting a strip made of a deformable material by means of a separating device according to claim 1, comprising:
transporting the strip, lying on the transport device, through the separating device along a transport direction;
cutting the strip by means of the cutting blade along a cutting surface, which runs in transport direction downwards from above diagonally through the strip lying on the transport device; and
raising the first edge relative to the second edge after the cutting of the strip, until a tip of the part of the strip which is not cut off has been transported over the second edge by the transport device.
